(19) United States
(12) Patent Application Publication
(10) Pub. No.: US 2025/0155384 A1
(43) Pub. Date: May 15, 2025

(54) ANALYSIS APPARATUS, ANALYSIS METHOD, AND PROGRAM FOR ANALYZING SCATTERING INTENSITY DISTRIBUTION

(71) Applicant: SAMSUNG ELECTRONICS CO., LTD., Suwon-si (KR)

(72) Inventors: Koji MURATA, Yokohama city (JP); Jaeyong Lee, Suwon-si (KR); Yukihide Tsuji, Suwon-si (KR); Yoshinori Sasai, Yokohama city (KR)

(73) Assignee: SAMSUNG ELECTRONICS CO., LTD., Suwon-ki (KR)

(21) Appl. No.: 18/941,965

(22) Filed: Nov. 8, 2024

(30) Foreign Application Priority Data
Nov. 9, 2023 (JP) 2023-191407
Dec. 12, 2023 (KR) 10-2023-0179706

(51) Int. Cl. G01N 23/20008

(52) U.S. Cl. CPC G01N 23/20008

(57) ABSTRACT

An analysis device includes at least one processor, and memory storing instructions that, when executed by the at least one processor, cause the analysis device to, based on electron density patterns of a plurality of adjacent layers matching each other in orthogonal mesh data of a plurality of first layers divided in a first direction, fuse the plurality of adjacent layers into a fused layer and determine layer information about the fused layer, and based on the layer information about the fused layer, determine a scattering intensity distribution of X-rays incident in the first direction on a target structure that is represented by the orthogonal mesh data.

### CROSS-REFERENCE TO RELATED APPLICATIONS

This application is based on and claims priority to Korean Patent Application No. 10-2023-0179706, filed on Dec. 12, 2023, in the Korean Intellectual Property Office, which is based on and claims priority to Japanese Patent Application No. 2023-191407, filed on Nov. 9, 2023, in the Japan Patent Office, the disclosures of which are incorporated by reference herein in their entireties.

### BACKGROUND

Example embodiments of the disclosure relate to an analysis device, an analysis method, and a program for analyzing scattering intensity distribution of X-rays.

There is a demand for technology to reduce the time required to analyze the scattering intensity distribution of X-rays.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide an analysis device that may be able to reduce the time required to analyze scattering intensity distribution of X-rays.

One or more example embodiments further provide an analysis method that may be able to reduce the time required to analyze scattering intensity distribution of X-rays, and a program for performing the same.

Additional aspects will be set forth in part in the description which follows and, in part, will be apparent from the description, or may be learned by practice of the presented embodiments.

According to an aspect of an example embodiment, an analysis device may include at least one processor, and memory storing instructions that, when executed by the at least one processor, cause the analysis device to, based on electron density patterns of a plurality of adjacent layers matching each other in orthogonal mesh data of a plurality of first layers divided in a first direction, fuse the plurality of adjacent layers into a fused layer and determine layer information about the fused layer, and based on the layer information about the fused layer, determine a scattering intensity distribution of X-rays incident in the first direction on a target structure that is represented by the orthogonal mesh data.

According to an aspect of an example embodiment, an analysis method may include, based on electron density patterns of a plurality of adjacent layers matching each other in orthogonal mesh data of a plurality of first layers divided in a first direction, fusing the plurality of adjacent layers into a fused layer and determining layer information about the fused layer, and based on the layer information about the fused layer, determining a scattering intensity distribution of X-rays incident in the first direction on a target structure that is represented by the orthogonal mesh data.

According to an aspect of an example embodiment, a computer-readable storage medium may store instructions that, when executed by at least one processor, cause the at least one processor to, based on electron density patterns of a plurality of adjacent layers matching each other in orthogonal mesh data of a plurality of first layers divided in a first direction, fuse the plurality of adjacent layers into a fused layer and determine layer information about the fused layer, and based on the layer information about the fused layer, determine a scattering intensity distribution of X-rays incident in the first direction on a target structure that is represented by the orthogonal mesh data.

### BRIEF DESCRIPTION OF DRAWINGS

The above and other aspects, features, and advantages of certain example embodiments of the present disclosure will be more apparent from the following description taken in conjunction with the accompanying drawings, in which;

FIG. 1 is a diagram illustrating a scattering vector of an X-ray that is emitted to a target structure according to one or more embodiments;

FIG. 2 is a block diagram illustrating an analysis device according to one or more embodiments;

FIG. 3 is a diagram illustrating an example of a target structure that is expressed as a rectangular parallelepiped mesh according to one or more embodiments;

FIG. 4 is a diagram illustrating a state in which a plurality of layers are fused into one layer by the analysis device according to one or more embodiments;

FIG. 5 is a diagram illustrating an example of list information that indicates an electron density pattern of layers according to one or more embodiments;

FIG. 6 is a diagram illustrating an example of a target structure that is expressed as a rectangular parallelepiped mesh according to one or more embodiments; and

FIG. 7 are images illustrating verification results of an analysis method according to related art and according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

For clarity of explanation, appropriate omissions and simplifications have been made in following description and drawings, and the dimensions of structures are enlarged from actual figures to ensure clarity of the embodiments.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Additionally, in the Equations described below, letters in bold font represent vectors. In the description, the phrase “(bold)” is provided next to variables that are vectors.

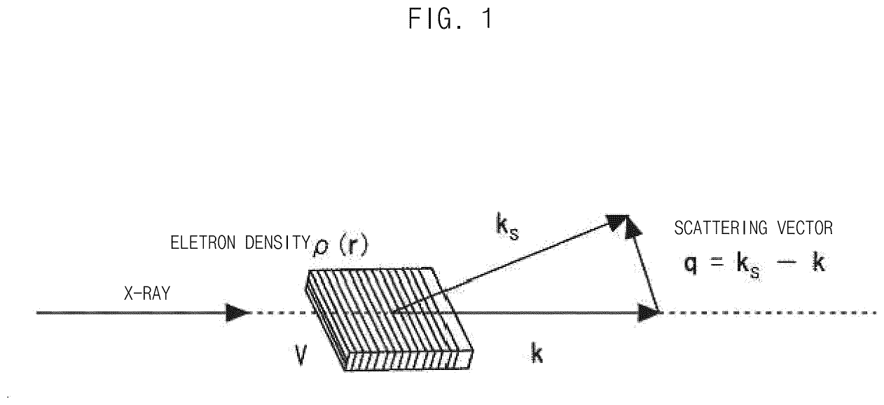

FIG. 1 is a diagram illustrating a scattering vector of an X-ray that is emitted to a target structure according to one or more embodiments.

A wave vector of X-ray may be expressed as k (bold), and a wave vector of a scattering vector may be expressed as ks (bold). A scattering vector q (bold) may be defined as ks (bold)—k (bold). In this case, scattering intensity distribution I (q (bold)) may be expressed as a square of the equation of three-dimensional (3D) Fourier transform that is obtained by solving the Schrödinger equation with the Born Approximation, as in Equation (1)

$$I ( q ) = {\vert \frac{1}{V} \int \int {\int }_{V} ρ ( r ) exp ( - iq \cdot r ) {d}^{3} r \vert}^{2} \qquad ( 1 )$$

If the incident X-ray has a spread represented by the distribution W (bold), the scattering intensity distribution Ismear (q (bold)) may be determined by a two-dimensional (2D) convolution integral, as expressed in Equation (2).

$${I}_{smear} ( q ) = \int \int W ( k ) I ( q - k ) {d}^{2} k \qquad ( 2 )$$

While Ismear (q (bold)) is 2D convolution integral, I (q (bold)) may be a 3D Fourier transform. Therefore, usually, the time taken to determine I (q (bold)) may be longer than the time taken to determine Ismear (q (bold)). In general, I (q (bold)) may be determined for a target structure that is modeled as a combination of primitive shapes, such as a cuboid or a cylinder, for which the three-dimensional Fourier transform may be solved analytically. However, structural data obtained through process simulation or topography simulation that reflects physical processes generally cannot be expressed using only primitive shapes and may need to be expressed as mesh. In addition, since the integral (3D Fourier transform) for the structure expressed as mesh cannot be solved analytically, it may be necessary to express the target structure as sufficiently fine rectangular mesh and then to solve the numerical integration, and accordingly, there is a problem that the time required to analyze the scattering intensity distribution of X-rays is long.

Therefore, one or more embodiments provide an analysis device, analysis method, and program that are able to reduce the time required to analyze the scattering intensity distribution when plane wave X-rays are emitted onto a complex structure represented by a rectangular parallelepiped mesh (or other mesh shapes as will be understood by those of ordinary skill in the art from the disclosure herein).

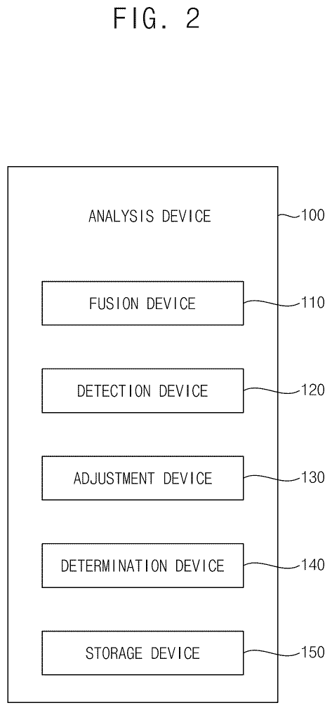

FIG. 2 is a block diagram illustrating an analysis device according to one or more embodiments. The analysis device 100 may be a computer device including a processor that performs various functions based on execution of instructions stored in a memory. The analysis device 100 may include a plurality of computer devices/processors. In this case, components or functions constituting the analysis device 100 may be distributed and arranged in a plurality of computer devices. The plurality of computer devices may be connected through a network or directly connected through a cable or the like. The processor/processors may include a central processing unit (CPU), a graphical processing unit (GPU), a field-programmable gate array (FPGA), etc. The analysis device 100 may include a single processor or multiple processors. In one or more embodiments, the analysis device 100 may include multiple devices/processors configured to perform independent functions from other devices/processors, as is described below. It will be understood by one or ordinary skill in the art from the disclosure herein that the devices described below may be implemented as a single processor or multiple processors.

The analysis device 100 may include a fusion device 110, a detection device 120, an adjustment device 130, a determination device 140, and a storage 150. The storage 150 may be a storage device accessible by the processor.

The fusion device 110 may determine whether, in orthogonal mesh data of a plurality of layers divided in Z direction in which X-rays are incident, electron density patterns of a plurality of adjacent layers match each other. The fusion device 110 may determine whether the electron density patterns match each other based on a threshold value. For example, the fusion device 110 may compare the electron density of the electron density pattern of a first mesh with the electron density of the electron density pattern of a second mesh corresponding to the first mesh. If the number of meshes with an electron density that is different from a corresponding mesh is less than the threshold value, the fusion device 110 may determine that the electron density patterns match each other.

The fusion device 110 may fuse a plurality of adjacent layers into one layer and may determine information about the fused one layer (layer information). The layer information may indicate, for example, the coordinates and thickness of the fused layer in the Z direction (or other directions).

The detection device 120 may detect whether or not the electron density patterns of a plurality of non-adjacent layers match. Similar to the fusion device 110, the detection device 120 may determine whether the electron density pattern match each other based on a threshold value. In particular, the detection device 120 may detect whether the electron density patterns of a plurality of the non-adjacent match each other after the fusion device 110 fuses a plurality of adjacent layers.

The adjustment device 130 may adjust the threshold values used for various determinations performed by the fusion device 110 and the detection device 120. The adjustment device 130 may adjust the threshold based on a user input (e.g., from a keyboard, a mouse, etc.).

The determination device 140 may determine a scattering intensity as in Equation (3).

$$F ( q ) = {\sum }_{k = 0}^{{N}_{z} - 1} {ρ}_{k} ( {q}_{m} , {q}_{n} ) exp ( {iq}_{z} {z}_{k} ) sinc ( \frac{{q}_{z} Δ {z}_{k}}{2} ) \frac{Δ {z}_{k}}{{L}_{z}} = {\sum }_{k = 0}^{{N}_{z} - 1} \frac{1}{{N}_{x} {N}_{y}} {\sum }_{i = 0}^{{N}_{x} - 1} {\sum }_{j = 0}^{{N}_{y} - 1} {ρ}_{k} ( {x}_{i} , {y}_{j} ) exp [ - 2 π i ( \frac{mi}{{N}_{x}} + \frac{nj}{{N}_{y}} ) ] exp ( - {iq}_{z} {z}_{k} ) sinc ( \frac{{q}_{z} Δ {z}_{k}}{2} ) \frac{Δ {z}_{k}}{{L}_{z}} \qquad ( 3 )$$

In Equation (3), the result of performing a 2D Fourier transform (for example, Fast Fourier transform) in the XY plane may be added in the Z direction. In Equation (3), qm and qn represent X and Y direction components of the scattering vector in terms of orders m and n, respectively. qz represents a Z direction component of the scattering vector. Lz represents a width in the Z direction of the rectangular parallelepiped mesh (analysis domain width). Nx, Ny, and Nz represent the mesh number (the number of cells) in the X, Y, and Z directions, respectively. i, j, and k represent mesh numbers (cell numbers) in the X, Y, and Z directions, respectively. The mesh width (cell width) at the kth layer is expressed as Δzk, and the electron density distribution is expressed as ρk(x, y). The mesh width may correspond to the thickness of the layer.

If the electron density patterns ρk(xi, yj) in a plurality of adjacent layers are identical to each other (that is, match each other), the determination for the plurality of layers by Equation (3) may be performed once. In this case, the coordinates and thickness of the Z direction of the fused layer may be substituted for zk and Δzk. The determination device 140 may perform a determination regarding the fused layer once based on the layer information determined by the fusion device 110. In Equation (3), the analytical solution of the integral included in Equation (1) may be used for the Z direction, and the mesh width in the Z direction (that is, the layer thickness), does not need to be relatively thin.

In addition, even if there are a plurality of non-adjacent layers, if the electron density patterns ρk(xi, yj) in the plurality of non-adjacent layers match, ρk(qm, qn), which is the result of the 2D Fourier transform, matches. Accordingly, the determination device 140 may effectively use the 2D Fourier transform result ρk(qm, qn) for the same electron density pattern ρk(xi, yj) based on the detection result of the detection device 120. In particular, when the determination device 140 provides the determination result of the 2D Fourier transform ρk(qm, qn) to the storage 150 and performs the determination for the layer having the corresponding electron density pattern, the determination result ρk(qm, qn) may be read from the storage 150. The determination device 140 may allocate the 2D Fourier transform for the electron density pattern of a plurality of adjacent layers or the electron density pattern of a plurality of non-adjacent layers to one of a plurality of processor cores, or may perform parallel processing in the plurality of processor cores. One 3D Fourier transform may be assigned to one processor core.

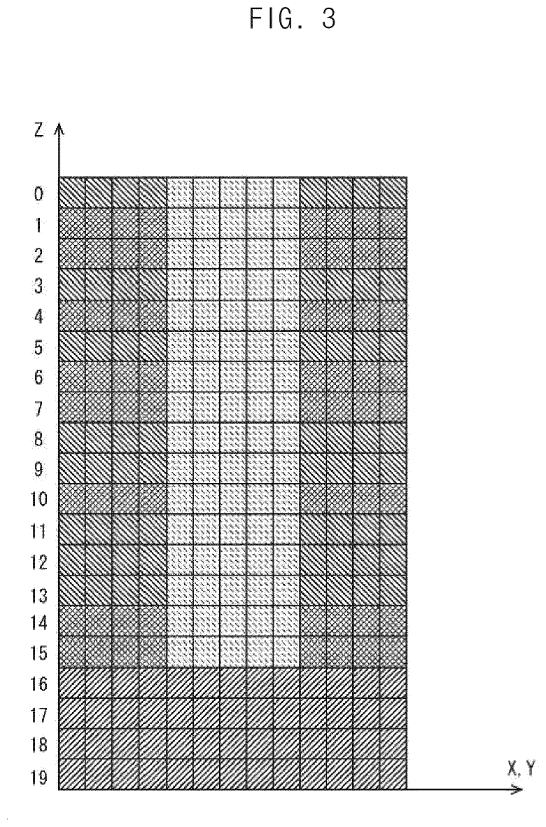

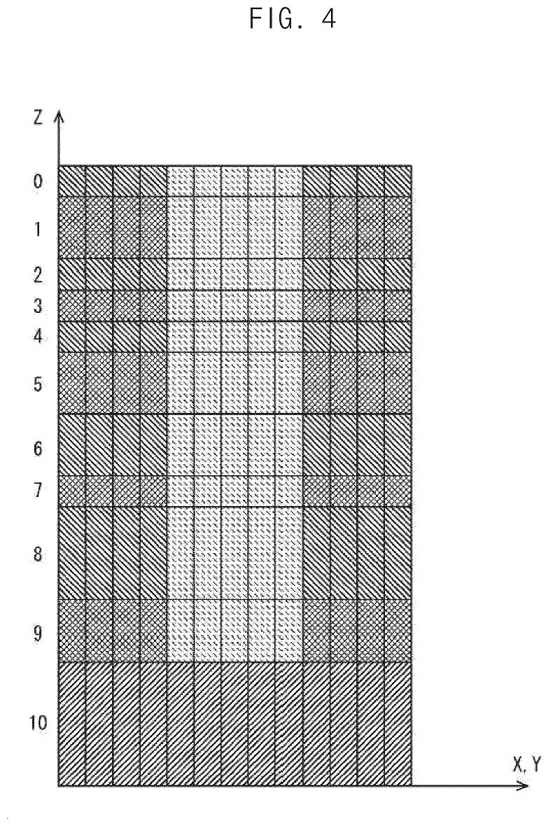

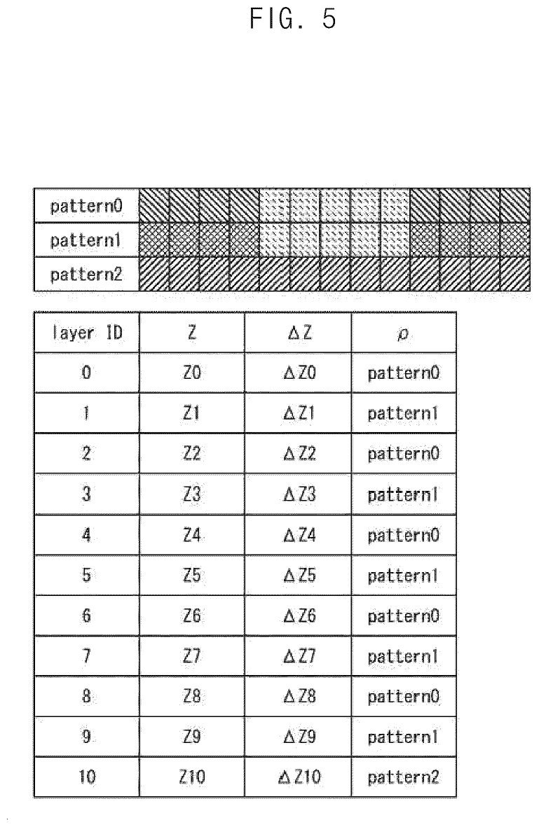

FIG. 3 is a diagram illustrating an example of a target structure that is expressed as a rectangular parallelepiped mesh according to one or more embodiments. FIG. 4 is a diagram illustrating a state in which a plurality of layers are fused into one layer by the analysis device according to one or more embodiments. FIG. 5 is a diagram illustrating an example of list information that indicates an electron density pattern of layers according to one or more embodiments. An operation of the analysis device 100 according to one or more embodiments will be explained in detail with reference to FIGS. 3, 4, and 5. FIG. 3 shows a target structure expressed as a rectangular parallelepiped mesh. For simplicity, the target structure is represented in two dimensions. The vertical direction represents the Z direction, and the horizontal direction represents the X or Y direction. Identical hatching meshes may correspond to identical electron densities. The target structure may include 20 layers, labelled 0 to 19.

The fusion device 110 of the analysis device 100 may determine whether the electron density patterns in adjacent layers match. The fusion device 110 may determine that the electron density patterns of the first and second layers match. The fusion device 110 may determine that the electron density patterns of the 6th and 7th layers match. The fusion device 110 may determine that the electron density patterns of the 11th to 13th layers match. The fusion device 110 may determine that the electron density patterns of the 14th and 15th layers match. The fusion device 110 may determine that the electron density patterns of the 16th to 19th layers match.

The fusion device 110 may fuse the layers with matching electron density patterns and may determine layer information (for example, thickness). FIG. 4 shows the target structure after the layers with the matching electron density patterns are fused. As shown in FIG. 4, the number of layers included in the target structure is reduced from 20 to 10. The layer information may be included in list information described later.

The detection device 120 of the analysis device 100 may detect whether or not the electron density patterns in non-adjacent layers in FIG. 4 match. The detection device 120 may detect that the electron density patterns of the 0th, 2nd, 4th, 6th, and 8th layers match. The detection device 120 may detect that the electron density patterns of the 1st, 3rd, 5th, 7th, and 9th layers match.

FIG. 5 illustrates an example of list information indicating the detection results of the detection device 120. For each layer within the target structure shown in FIG. 4, the coordinate Z, thickness AZ and number p of the electron density pattern are shown. Pattern 0 represents the electron density pattern of the 0th, 2nd, 4th, 6th, and 8th layers of FIG. 4. Pattern 1 represents the electron density pattern of the 1st, 3rd, 5th, 7th, and 9th layers. Pattern 2 represents the electron density pattern of the 10th layer. According to the detection result of the detection device 120, Equation (4) may be obtained from Equation (3).

$$F ( q ) = \frac{1}{{L}_{z}} \{ {ρ}_{{k}_{A}} ( {q}_{m} , {q}_{n} ) {\sum }_{k = {k}_{A}} {e}^{- {iq}_{z} {z}_{k}} sinc ( \frac{{q}_{z} Δ {z}_{k}}{2} ) Δ {z}_{k} + {ρ}_{{k}_{B}} ( {q}_{m} , {q}_{n} ) {\sum }_{k = {k}_{B}} {e}^{- {iq}_{z} {z}_{k}} sinc ( \frac{{q}_{z} Δ {z}_{k}}{2} ) Δ {z}_{k} {+}_{{k}_{C}} ( {q}_{m} , {q}_{n} ) {\sum }_{k = {k}_{C}} {e}^{- {iq}_{z} {z}_{k}} sinc ( \frac{{q}_{z} Δ {z}_{k}}{2} ) Δ {z}_{k} \} \qquad ( 4 )$$

In Equation (4), ρk_{A}(qm, qn), ρk_{B}(qm, qn) and ρk_{C}(qm, qn) represent the results of the 2D Fourier transform for pattern 0, pattern 1 and pattern 2, respectively. K_{A}, K_{B} and k_{C} represent layers having pattern 0, pattern 1 and pattern 2 as the electron density pattern, respectively.

Then, the determination device 140 may determine the scattering intensity distribution according to Equation (4). The determination device 140 may perform a Fast Fourier transform when determining ρk_{A}(qm, qn), ρk_{A}(qm, qn) and ρk_{C}(qm, qn).

In one or more embodiments, the fusion device 110 may reduce the number of layers from 20 to 1, thereby reducing the number of times the Fast Fourier transform is performed from 20 to 11. Additionally, by using the list information, such as the list information shown in FIG. 5, the number of times to perform the Fast Fourier transform may be reduced to three, and the processing speed is expected to increase by a factor of 6.67 (=20/3).

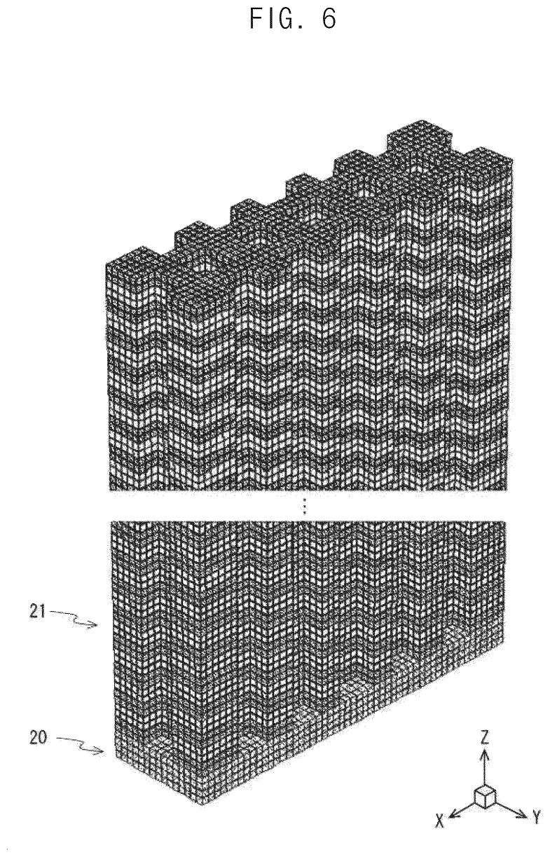

FIG. 6 is a diagram illustrating an example of a target structure that is expressed as a rectangular parallelepiped mesh according to one or more embodiments. In particular, the scattering intensity distribution when X-rays were emitted to a three-dimensional structure of an object schematically shown in FIG. 6 were observed. In FIG. 6, the mesh illustrated is a rough depiction compared to structures actually used for examination. A hole of a rectangular parallelepiped shape may be formed in a multilayer 21 on a substrate 20 of a rectangular parallelepiped shape. The substrate 20 and the multilayer 21 are stacked in the Z direction. Meshes with the same hatching are associated with the same material (i.e. the same electron density).

In FIG. 6, the target structure is divided into 4208 divisions in the X direction, 1216 divisions in the Y direction, and 5200 divisions in the Z direction. Sampling points of X component qx[1/nm] and Y component qy[1/nm] of the scattering vector to 4208 and 1216 were set, respectively. In one studied example, when using Equation (3) without fusing layers with matching electron density patterns or using the results of a Fast Fourier transform, the processing time for the scattering intensity distribution was 1877 seconds. On the other hand, when fusing layers with matching electron density patterns and using the results of the fast Fourier transform according to one or more embodiments, the processing time of the scattering intensity distribution was 13 seconds. Accordingly, even considering the time of 41 seconds required to detect a layer with a matching electron density pattern, the processing speed according to one or more embodiments is 34.8 times that of related art techniques.

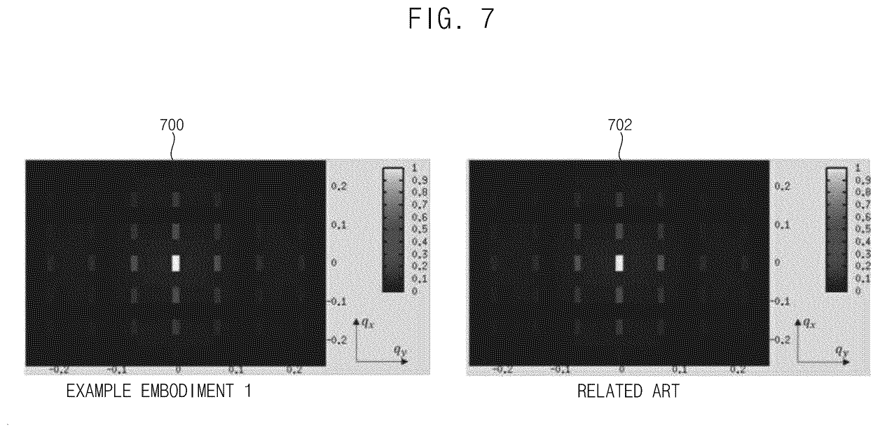

FIG. 7 are images illustrating verification results of an analysis method according to related art and according to one or more embodiments. As shown in FIG. 7, the results of determining the scattering intensity distribution using the related art in image 700 and the results of determining the scattering intensity distribution using one or more embodiments in image 702 are shown. In the images 700 and 702, the square root of the scattering intensity distribution is shown for a main portion of the scattering vector and is normalized such that the intensity at qx=qy=0 is 1. For the entire area, the maximum absolute value of the difference at each point between the result according to one or more embodiments and the result according to the related art is 1.16*e-71, which is sufficiently small.

According to one or more embodiments, the number of 2D Fourier transforms and processing time may be reduced by fusing a plurality of adjacent layers. Additionally, by using information on a plurality of non-adjacent layers with identical (matching) electron density distributions, the number of 2D Fourier transforms may be further reduced and processing time may be further reduced.

According to one or more embodiments, an analysis device, an analysis method, and a program that is able to reduce the time required to analyze scattering intensity distribution of X-rays may be provided.

As used in connection with various embodiments of the disclosure, the term “device” may include a unit implemented in hardware, software, or firmware, and may interchangeably be used with other terms, for example, logic, logic block, part, or circuitry. A device may be a single integral component, or a minimum unit or part thereof, adapted to perform one or more functions. For example, according to an embodiment, the device may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. By way of example, and not limitation, storage media or tangible storage media may include random-access memory (RAM), read-only memory (ROM), flash memory, solid-state drive (SSD) or other memory technology, CD-ROM, DVD (digital versatile disc), Blu-ray (registered trademark) disk or other optical disk storages, magnetic cassettes, magnetic tapes, magnetic disk storages, or other magnetic storage devices.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a device or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., devices or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the device, the program, or another component may be carried out sequentially, in parallel, repeatedly, or heuristically, or one or more of the operations may be executed in a different order or omitted, or one or more other operations may be added.

At least one of the devices, units, components, devices, units, or the like represented by a block or an equivalent indication in the above embodiments including, but not limited to, FIG. 2, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An analysis device, comprising:
at least one processor; and
memory storing instructions that, when executed by the at least one processor, cause the analysis device to:
based on electron density patterns of a plurality of adjacent layers matching each other in orthogonal mesh data of a plurality of first layers divided in a first direction:
fuse the plurality of adjacent layers into a fused layer; and
determine layer information about the fused layer; and
based on the layer information about the fused layer, determine a scattering intensity distribution of X-rays incident in the first direction on a target structure that is represented by the orthogonal mesh data.

2. The analysis device of claim 1, wherein the instructions, when executed by the at least one processor, further cause the analysis device to:
determine whether electron density patterns of a plurality of non-adjacent layers match.

3. The analysis device of claim 2, wherein the instructions, when executed by the at least one processor, further cause the analysis device to determine whether the electron density patterns of the plurality of non-adjacent layers match after the plurality of adjacent layers are fused.

4. The analysis device of claim 2, wherein the instructions, when executed by the at least one processor, further cause the analysis device to:
based on the electron density patterns of the plurality of non-adjacent layers matching, send a determination result of a two-dimensional Fourier transform of the matching electron density pattern of the plurality of non-adjacent layers to a storage device.

5. The analysis device of claim 4, wherein the instructions, when executed by the at least one processor, further cause the analysis device to:
read the determination result from the storage device; and
perform a calculation for a layer having the matching electron density pattern based on the determination result read from the storage device.

6. The analysis device of claim 4, wherein the instructions, when executed by the at least one processor, further cause the analysis device to:
allocate the two-dimensional Fourier transform to one of a plurality of processor cores of the at least one processor; and
performs parallel processing in the plurality of processor cores.

7. The analysis device of claim 2, wherein the instructions, when executed by the at least one processor, further cause the analysis device to:
determine whether the electron density patterns of the plurality of adjacent layers match and a second threshold for determine whether the electron density patterns of the plurality of non-adjacent layers match based on a threshold value corresponding a predetermined number of meshes.

8. An analysis device, comprising:
at least one processor; and
memory storing instructions that, when executed by the at least one processor, cause the analysis device to:
in orthogonal mesh data of a plurality of first layers divided in a first direction:
determine whether electron density patterns of a plurality of adjacent layers match each other based on a first threshold value;
fuse the plurality of adjacent layers into a fused layer; and
determine layer information about the fused layer; and
based on the layer information about the fused layer, determine a scattering intensity distribution of X-rays incident in the first direction on a target structure that is represented by the orthogonal mesh data.

9. The analysis device of claim 8, wherein the instructions, when executed by the at least one processor, further cause the analysis device to:
determine whether electron density patterns of a plurality of non-adjacent layers match.

10. The analysis device of claim 9, wherein the instructions, when executed by the at least one processor, further cause the analysis device to determine whether the electron density patterns of the plurality of non-adjacent layers match after the plurality of adjacent layers are fused.

11. The analysis device of claim 9, wherein the instructions, when executed by the at least one processor, further cause the analysis device to:
based on the electron density patterns of the plurality of non-adjacent layers matching, send a determination result of a two-dimensional Fourier transform of the matching electron density pattern of the plurality of non-adjacent layers to a storage device.

12. The analysis device of claim 11, wherein the instructions, when executed by the at least one processor, further cause the analysis device to:
read the determination result from the storage device; and
perform a calculation for a layer having the matching electron density pattern based on the determination result read from the storage device.

13. The analysis device of claim 11, wherein the instructions, when executed by the at least one processor, further cause the analysis device to:
allocate the two-dimensional Fourier transform to one of a plurality of processor cores; and
perform parallel processing in the plurality of processor cores.

14. The analysis device of claim 9, wherein the instructions, when executed by the at least one processor, further cause the analysis device to:
determine whether the electron density patterns of the plurality of adjacent layers match and a second threshold for determine whether the electron density patterns of the plurality of non-adjacent layers match based on a threshold value corresponding a predetermined number of meshes.

15. An analysis device, comprising:
a fusion device that is configured to, in orthogonal mesh data of a plurality of first layers divided in a first direction, determine whether electron density patterns of a plurality of adjacent layers match each other based on a first threshold value, fuse the plurality of adjacent layers into a fused layer and determine layer information about the fused layer; and
a determination device that is configured to determine a scattering intensity distribution of X-rays incident in the first direction on a target structure that is represented by the orthogonal mesh data, based on the layer information about the fused layer.

16. The analysis device of claim 15, further comprising:
a detection device that is configured to determine whether electron density patterns of a plurality of non-adjacent layers match.

17. The analysis device of claim 16, wherein the detection device is configured to determine whether the electron density patterns of the plurality of non-adjacent layers match after the plurality of adjacent layers are fused.

18. The analysis device of claim 16, wherein the determination device that is configured to:
based on the electron density patterns of the plurality of non-adjacent layers matching, send a determination result of a two-dimensional Fourier transform of the matching electron density pattern of the plurality of non-adjacent layers to a storage device.

19. The analysis device of claim 18, wherein the determination device that is configured to:
read the determination result from the storage device; and
perform a calculation for a layer having the matching electron density pattern based on the determination result read from the storage device.

20. The analysis device of claim 16, further comprising:
an adjustment device that is configured to determine whether the electron density patterns of the plurality of adjacent layers match and a second threshold for determine whether the electron density patterns of the plurality of non-adjacent layers match based on a threshold value corresponding a predetermined number of meshes.
